(19) United States
(12) Patent Application Publication
(10) Pub. No.: US 2017/0320720 A1
(43) Pub. Date: Nov. 9, 2017

(54) HOLSTER FOR HANDHELD BEVERAGE DISPENSERS

(71) Applicant: Automatic Bar Controls, Inc., Vacaville, CA (US)

(72) Inventors: Thomas R. Hecht, Winters, CA (US); Richard A. Martindale, Vacaville, CA (US); Bret D. Baker, Vacaville, CA (US)

(21) Appl. No.: 15/599,325

(22) Filed: May 18, 2017

Related U.S. Application Data
(63) Continuation-in-part of application No. 14/795,874, filed on Jul. 9, 2015.
(60) Provisional application No. 62/022,549, filed on Jul. 9, 2014.

(51) Int. Cl. B67D 1/16; F16L 3/00; B67D 1/08

(52) U.S. Cl. CPC B67D 1/16; F16L 3/003; B67D 1/0889

(57) ABSTRACT

Disclosed is a holster for a bar gun. The holster includes a detachable drip cup that is removable from the holster while the holster is installed to a support structure and while the bar gun is stowed in the holster. The holster is mounted to an underside of the support structure, e.g. a bar top, and further includes a first contact surface configured to be vertical and contact the front side of the support structure and a second contact surface configured to be horizontal and contact the underside of the support structure. The holster further includes an a bar gun receiving surface defining an aperture to receive the bar gun. The bar gun receiving surface includes a portion which is flush with the top surface of the support structure, when the holster is mounted to the support structure.

### CROSS-REFERENCES TO RELATED APPLICATIONS

This application is a continuation-in-part of U.S. application Ser. No. 14/795,874, filed on Jul. 9, 2015, which claims the benefit of U.S. Provisional Application No. 62/022,549, filed on Jul. 9, 2014, both of which are incorporated by reference herein.

### BACKGROUND OF THE INVENTION

Beverage dispensers include carbonated beverage dispensers, non-carbonated beverage dispensers, beverage brewing systems, and liquor distribution systems. Many beverage dispenser designs have separate nozzles to pour (dispense) different beverages. Some beverage dispensers are capable of dispensing a variety of beverages out of a single nozzle. Beverage dispensing systems are commonly used in a wide variety of locales, including restaurants, snack bars, convenience stores, movie theaters, and any business where beverages are served.

Some beverage dispensing systems are in the form of a hand held beverage dispensing handle, or bar gun. The bar gun may use a single nozzle for dispensing multiple different beverages depending on the needs of the end user. Buttons are used to activate valves inside the bar gun to control the flow of a beverage from the beverage system. The buttons and valves are located on the top side of the bar gun for ease of use when dispensing a beverage. Users of bar guns often dispense a beverage when working in establishments such as the ones listed above, and also may have other tasks including, cleaning, organizing, stocking and being a cashier, among other tasks. When performing these tasks, it is often necessary to stow the bar gun in a holster when not in use to prevent contamination.

Bar gun holsters may have drip cups for containing and draining excess beverage that drips from the nozzle of the bar gun when the bar gun is stowed in the holster. Maintaining and cleaning the drip cup of existing bar gun holsters in order to prevent contamination and clogging of the drip cup and drain of the drip cup can be difficult because the portion of the holster holding the bar gun, or the entire holster, must be uninstalled, from the support structure that it is attached to, in order to remove the drip cup for cleaning or for maintenance. This is undesirable because the bar gun will no longer be supported in the mounted holster and may therefore be set down on a surface where it may be contaminated while the drip cup is being cleaned or maintained.

Further, during routine use, beverage liquids may drip from the nozzle of the bar gun onto outer surfaces of the bar gun holster, particularly around the aperture which receives the bar gun, and also onto surfaces of the support structure proximate to the holster. With existing holsters, the surface around the aperture extends into a surface which contacts the underside of the support structure. Dripped liquid therefore tends to seep between the holster and the underside of the support structure. This seeped liquid may be problematic because liquid may accumulate in this hard to reach spot and may lead to contamination, such as mold and bacteria growth.

### BRIEF SUMMARY OF THE INVENTION

The present invention relates to beverage dispensers. More specifically, the present invention relates to a holster for a bar gun. The holster includes a detachable drip cup that is removable from the holster while the holster is installed to a support structure and while the bar gun is stowed in the holster. The holster is mounted to an underside of the support structure, e.g. a bar top, and further includes a first contact surface configured to be vertical and contact the front side of the support structure and a second contact surface configured to be horizontal and contact the underside of the support structure. The holster further includes a bar gun receiving surface defining an aperture to receive the bar gun. The bar gun receiving surface includes a portion which is flush with the top surface of the support structure, when the holster is mounted to the support structure.

The detachable drip cup has the advantages of allowing the bar gun holster to remain attached to the support structure and retain the bar gun while the drip cup is removed to be maintained and cleaned. This reduces the likelihood of the bar gun becoming contaminated due to being placed on an unclean surface. The portion of the bar gun receiving surface which is flush with the top surface of the support structure has the advantages of reducing accumulation of dripped liquid on the bar gun holster and in crevices between the bar gun holster and support structure, which may lead to contamination.

### BRIEF DESCRIPTION OF THE DRAWINGS

FIG. 1 shows an exploded perspective view of an assembly comprising a bar gun holster, drip cup and bar gun in accordance with embodiments of the present invention.

FIG. 2 shows an exploded perspective view of the assembly of FIG. 1, with the bar gun stowed in the holster.

FIG. 3 shows a perspective view of the holster and drip cup of the assembly of FIG. 1 affixed to a support structure.

FIG. 4 shows a bottom disassembled perspective view of the bar gun holster and drip cup of FIG. 1.

FIGS. 5A-5F show a cross-sectional view of the drip cup of FIG. 1 being sequentially attached to the bar gun holster of FIG. 1.

### DETAILED DESCRIPTION OF THE INVENTION

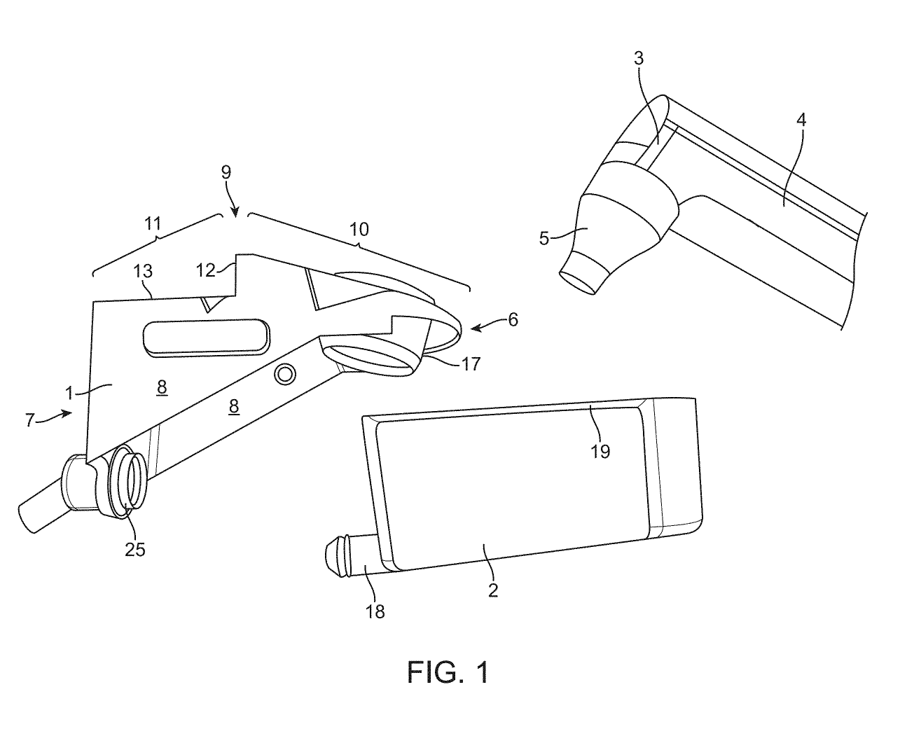

FIG. 1 shows an exploded perspective view of an assembly comprising a bar gun holster 1, drip cup 2 and bar gun 3 in accordance with one embodiment of the present invention. The bar gun 3 has a handle 4 with buttons on its top side and a nozzle 5 for dispensing a beverage. The handle and buttons are configured so an operator can hold the bar gun 3 in one hand and press one of the buttons to selectively dispense a particular beverage, depending on the desire of the operator, from the nozzle 5. Beverages are fed into the bar gun 3 by beverage fluid lines (not shown) encased in a flexible tubing that extends off of the back end of the bar gun 3.

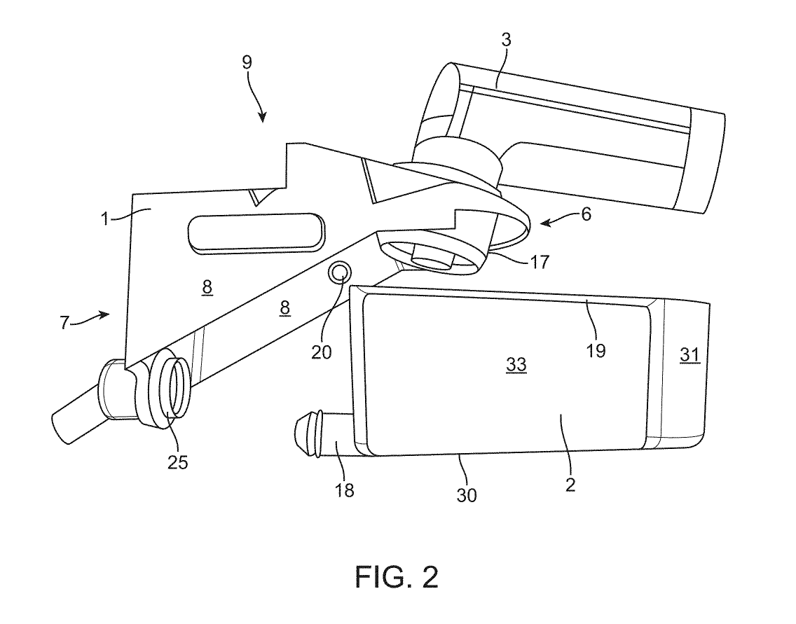

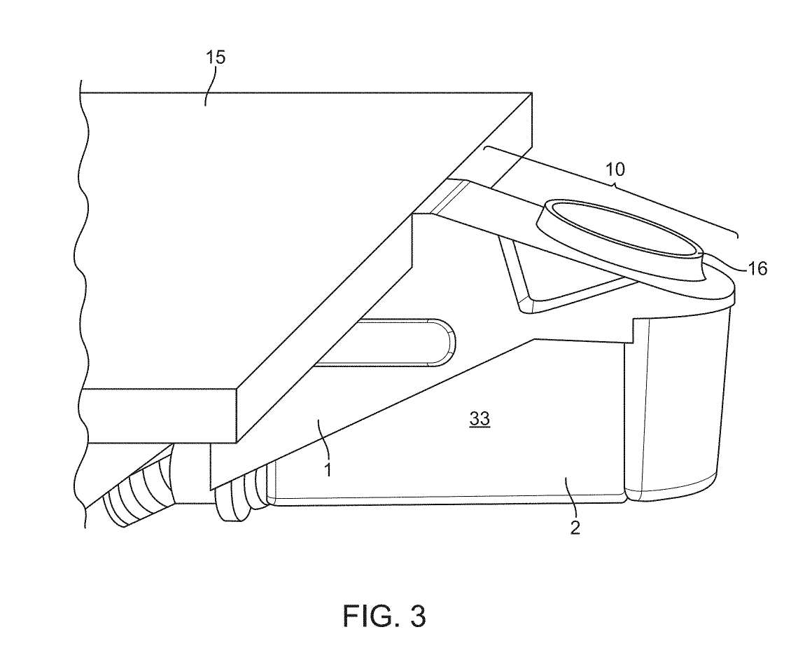

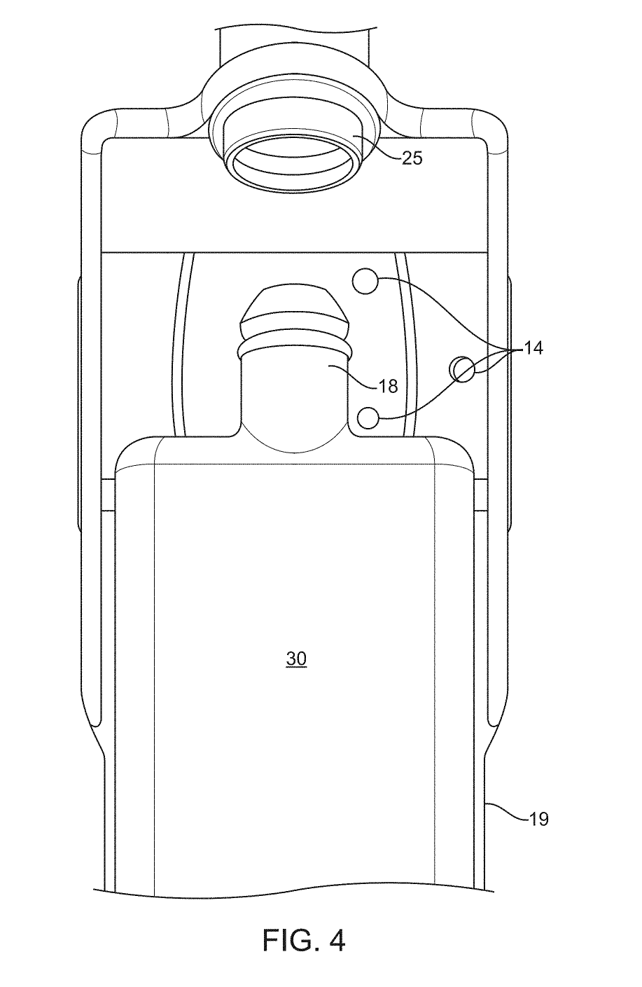

The bar gun holster 1 has a front portion 6, a back portion 7, two side portions 8 and a top portion 9. The side portions 8 have a generally triangular shape and extend between the top portion 9 and the back portion 7, as shown in FIG. 2. The top portion 9 includes a bar gun receiving surface 10 toward the front portion 6, and a mounting interface 11 toward the back portion 7. The mounting interface includes a first contact surface 12 configured to contact the front side surface of the support structure and a second contact surface 13 configured to contact the underside of the support structure. In embodiments, the first and second contact surface may be substantially flat, or may be contoured to match contours of the support structure. For example if the support structure has a curved front surface, the first contact surface may have a matching curved surface. The first and/or second contact surface may include mounting holes 14 for fasteners, e.g. screws, for securing the bar gun holster to the support structure. As shown in FIG. 3, the holster may be mounted to the underside of a table or countertop 15. As shown in FIG. 4, mount holes 14 defined by second contact surface 13 may be used to affix the bar gun holster to the support structure with screws.

The bar gun receiving surface 10 extends from the first contact surface 12 to the front portion 6 of the holster 1, and includes an aperture 16 for accepting the nozzle 5 of the bar gun 3. The bar gun receiving surface 10 may include one or more facets which may each be flat or curved. The aperture 16 is sized and configured so the nozzle 5 can fit into the aperture and support the bar gun so that the handle extends away from the front portion of the holster, as shown in FIG. 2. In embodiments, when mounted, as shown in FIG. 3, the bar gun receiving surface 10 including the aperture 16 is angled slightly downwardly from the top surface of the countertop 15. The first contact surface 12 is sized so that when installed the bar gun receiving surface 10 forms a flush transition with the top surface of the countertop 15. With the flush transition, the downward angle is beneficial in preventing liquid dripped around the interface of the holster and support structure from pooling and also assists with facilitating the liquid to roll off of the holster, for example onto a floor which may include a drain. Prevention of pooling of liquid on the holster is beneficial because it reduces the likelihood of liquid seeping in crevasses between the holster and countertop which are difficult to clean and therefore may lead to contamination.

In embodiments, the aperture 16 includes an aperture sidewall 17 which extends downwards and forms a cylindrical sleeve that aids in retaining the nozzle 5, as is shown in FIG. 2.

As shown in FIG. 3, the drip cup 2 attaches to the bottom side of the holster 1. The drip cup 2 defines an open cavity that is open on the top side of the drip cup 2. The cavity is defined by a bottom wall 30, a front wall 31, a back wall 32 and two side walls 33. The back wall 32 includes a drain outlet 18 proximate to the bottom wall 30, as shown in FIG. 2. In embodiments, the back wall, sidewalls and front wall define an upper rim of the drip cup. As shown, in embodiments, the upper rim is substantially on a plane. When installed, the drip cup 2 and bottom side of the bottom surface of top portion 9 define an enclosed volume which is beneficial in preventing exposure, and therefore contamination, of the nozzle 5 of the bar gun 3 from the environment when the bar gun is holstered. In embodiments, the back wall 32 includes at least a portion that does not extend up to the plane of the rim, which creates additional clearance for sliding the drip cup past the nozzle during installation of the drip cup.

The drip cup further includes guide rails 19 along at least a portion of the top of the side walls 33 along the rim. The holster includes first protrusions 20 extending inwardly from each of the two side portions 8. The first protrusions are configured to define of portion of a glide path for detachably mounting and dismounting the drip cup 2 to/from the holster 1. The glide path is defined so that the drip cup may be installed and uninstalled without removing the bar gun from the holster, and therefore the drip cup may freely move past the aperture 16 and aperture sleeve 17, with or without the bar gun holstered. In embodiments, to install the drip cup 2, the leading ends of the guide rails 19, located proximate to the back wall of the drip cup, are positioned between the first protrusions 20 and the bar gun receiving surface 10 of the holster 1. In this orientation the drip cup 2 may be located at an angle relative to horizontal. The drip cup 2 is then slid along the glide path, which may be a straight or curved path, and which terminates at a terminal position in which the nozzle 5 is encapsulated within the cavity defined by the drip cup 2 and bottom surface of top portion 9 of the holster 1. When the drip cup 2 reaches the terminal positon, the drain outlet 18 of the drip cup 2 is received into a drain access port 25 located toward the bottom of the back portion of the holster.

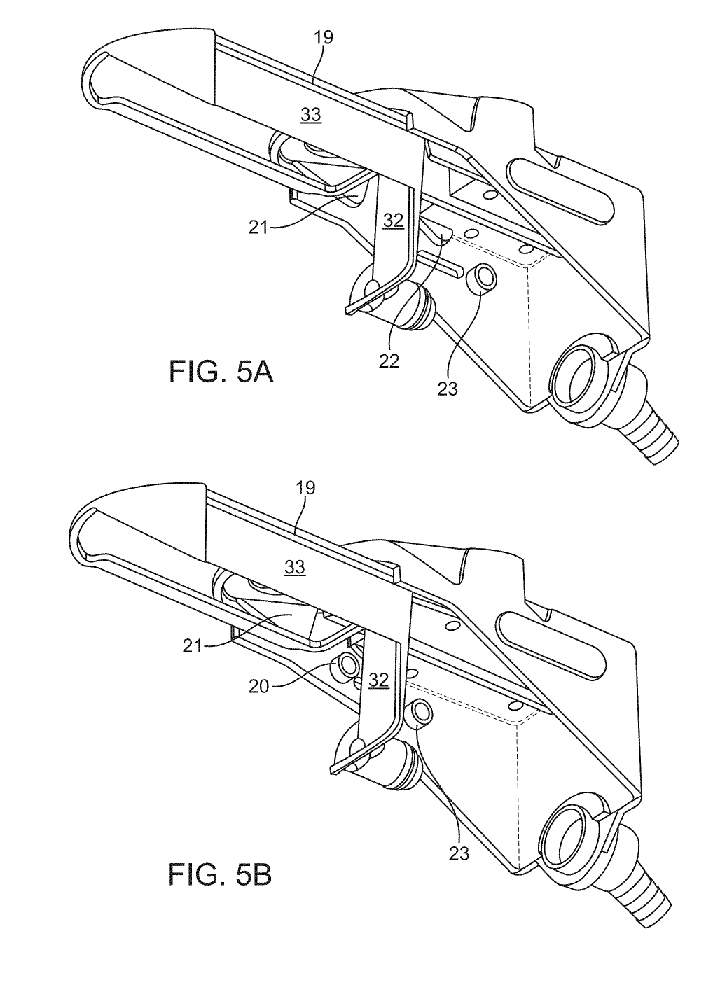

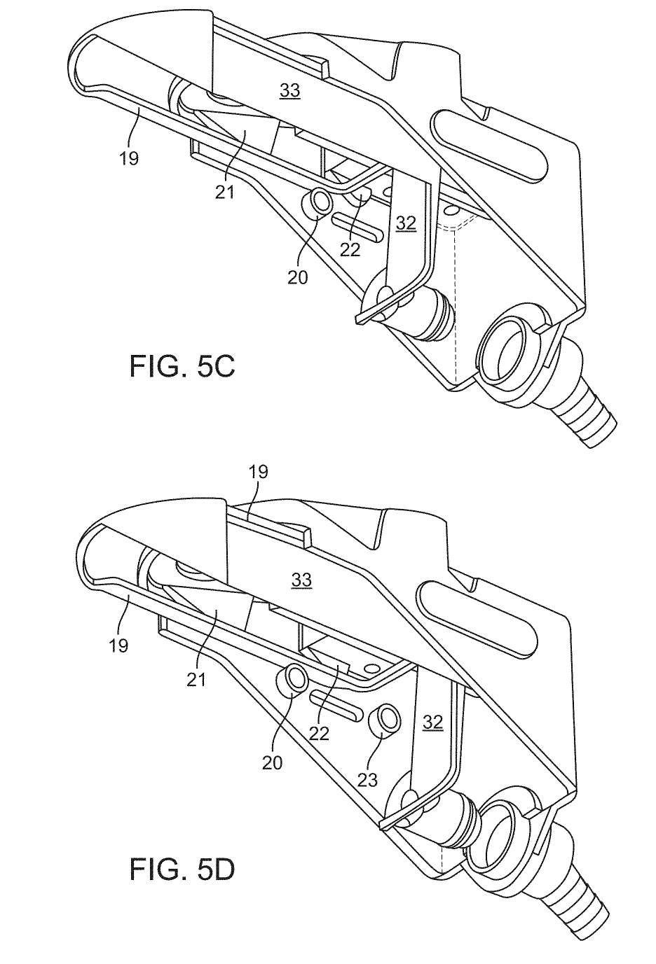

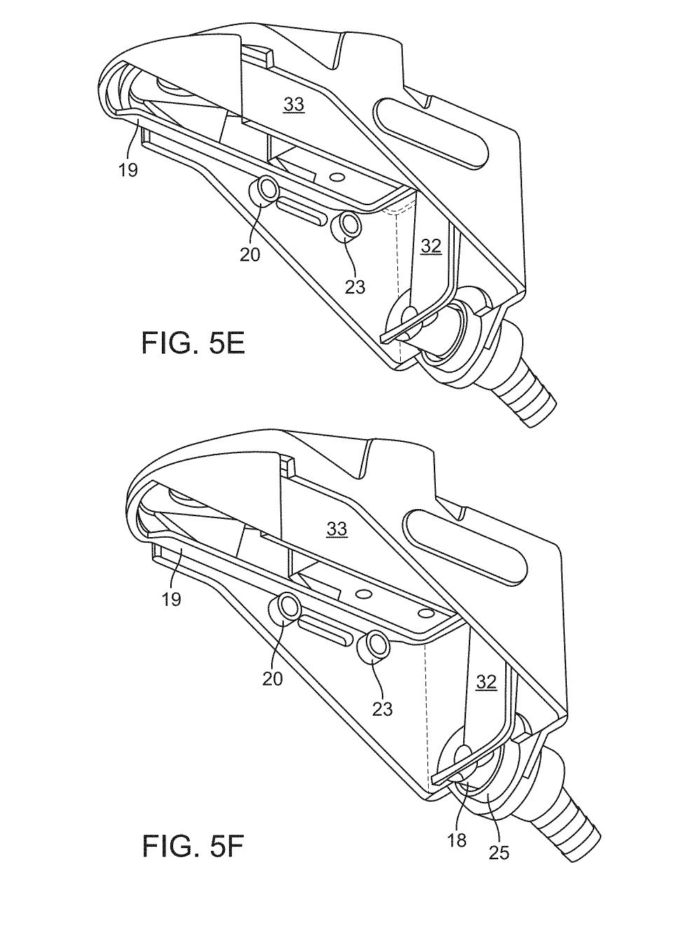

FIG. 5A-5F show a mounting process of the drip cup and holster wherein only a partial view of the drip cup is shown, specifically wherein portions of the front, side bottom and back walls are omitted for clarity purposes. FIG. 5A-5F show a sequence of stages of attachment of the drip cup to a bar gun holster. As shown in FIG. 5A, to attach the drip cup 2 to the holster 1, the guide rails 19 are placed between the side portions 8 of the holster with the back wall of the drip cup 2 proximate to the aperture 16. Note that in embodiments, the holster 1 may not include an aperture sleeve 17. In embodiments, the holster 1 may include first guide ramps 21 extending inwardly from the side portions 8 and having guide surfaces configured to guide the guide rails downwardly and toward the back portion 9 of the holster. As shown in FIG. 5B, as the drip cup 2 is inserted, the guide rails may travel along the bottoms of the first guide ramps 21. As shown in FIG. 5C, as the drip cup 2 is further inserted, the guide rails reach the first protrusions 20 and travel along the bottoms of the first guide ramps 21 and the tops of the first protrusions 20. In embodiments, the holster may further include second guide ramps 22 located between the first protrusions 20 and the back portion 7 of the holster 1. The second guide ramps 22 include bottom surfaces configured to guide the top surfaces of the guide rails 19, as shown in FIG. 5D. In embodiments, the holster may further include second protrusions 23 located between the second guide ramp 22 and the back portion 7 of the holster 1. The second protrusions 23 include top surfaces configured to guide the bottom surfaces of the guide rails 19, as shown in FIG. 5E. As shown in FIG. 5F, as the drip cup 2 reaches the terminal position the top surface of the guide rails 19 is guided by first and second guide ramps 21 and 22, and the bottom surface of the guide rails are guided by the first and second protrusions. Further, as shown in FIG. 5F, as the drip cup reaches the terminal position, the drain outlet 18 of the drip cup 2 is received into a drain access port 25 of the holster 1.

The holster may be formed as a single piece or may comprise multiple portions which are assembled together. Assembly in multiple pieces may allow for geometries that are difficult or more expensive to achieve with common single piece plastic molding techniques. The assembly may include a main body and inserts for forming features for attaching the drip cup. For example, the main body may define openings on the side portions, and an insert including two protrusions may be inserted into the openings to create the first and second protrusions discussed above.

The above description is illustrative and is not restrictive. A recitation of “a”, “an” or “the” is intended to mean “one or more” unless specifically indicated to the contrary. Many variations of the disclosure will become apparent to those skilled in the art upon review of the disclosure. One or more features from any embodiment described herein, and including embodiments described in applications incorporated by reference, may be combined with one or more features of any other embodiment without departing from the scope of the disclosure. The scope of the disclosure should, therefore, be determined not with reference to the above description, but instead should be determined with reference to the pending claims along with their full scope or equivalents.

What is claimed is:

1. An assembly for use with a bar gun, the bar gun including a nozzle, the bar gun connected to multiple fluid lines communicating with the nozzle, the assembly comprising:
a holster comprising a mounting portion configured to be attached to a support structure, and a bar gun receiving portion, the bar gun receiving portion defining an aperture to receive the bar gun nozzle; and
a drip cup, wherein the drip cup is removably attached to the holster and is configured to be detached and attached to the holster with the holster attached to the support structure.

2. The assembly of claim 1, wherein the mounting portion comprises, a first surface configured to contact a vertical side portion of the support structure, and a second surface configured to contact an underside of the support structure, wherein the first surface is configured so that when the holster is attached to the support structure the bar gun receiving portion forms a flush transition with a top surface of the support structure.

3. The assembly of claim 1, wherein the drip cup comprises a pair of guide rails extending from opposing sides of the drip cup,
wherein the holster comprises a pair of side portions,
wherein at least one protrusion extends inwardly from each side portion, and
wherein the protrusions define a glide path for the drip cup.

4. The assembly of claim 3, wherein the aperture includes a sleeve extending downwardly and the glide path is defined to allow the drip cup to be installed around the sleeve.

5. The assembly of claim 3, wherein the glide path is defined as a straight line.

6. The assembly of claim 3, wherein the glide path is defined to include curved portions.
